(19) United States
(12) Patent Application Publication
(10) Pub. No.: US 2004/0008515 A1
(43) Pub. Date: Jan. 15, 2004

(54) Fluorescence illumination optimization for three-dimensional microscopy

(75) Inventors: Carl S. Brown, Seattle, WA (US); James A. Roecker, Bellevue, WA (US); Peter C. Lombrozo, Aptos, CA (US); Paul C. Goodwin, Shoreline, WA (US)

Correspondence Address: Pillsbury Winthrop LLP, Intellectual Property Group, Suite 200, 11682 El Camino Real., San Diego, CA, 92130-2092, US

(73) Assignee: Applied Precision

(21) Appl. No.: 10/460,757

(22) Filed: Jun. 11, 2003

Related U.S. Application Data
(60) Provisional application No. 60/388,128, filed on Jun. 11, 2002.

(51) Int. Cl. F21V 1/00

(52) U.S. Cl. 362/277

(57) ABSTRACT

A fluorescence microscopy system and method allow selective and repeatable switching between Köhler illumination, providing a relatively large field of view, and Critical Illumination, providing a relatively higher axial resolution. This switching or toggle function may be facilitated by a feature associated with an alignment module that allows the focus of the fiber tip, for example, to be selectively and repeatably transitioned between the back aperture of the objective lens and the object plane without losing optical alignment.

The present application claims the benefit of U.S. provisional application Serial No. 60/388,128, filed Jun. 11, 2002, entitled “METHOD AND APPARATUS FOR OPTIMIZING FLUORESCENCE ILLUMINATION FOR THREE DIMENSIONAL MICROSCOPY.”

### FIELD OF THE INVENTION

Aspects of the present invention relate generally to illumination techniques for use in microscopy systems, and more particularly to a system and method of optimizing fluorescence illumination for three-dimensional microscopy applications.

### DESCRIPTION OF THE RELATED ART

Fluorescence microscopy is well described in the art and is commonly used for the examination of biological materials. The use of fluorescence microscopy for the purpose of examining three-dimensional (3D) structural characteristics of biological materials by use of confocal microscopy is also generally known (Pawley, 1995). Wide-field fluorescence microscopy has been described in publications (see, for example, Inoue and Spring, 1997), as has image restoration microscopy (Agard, et al., 1989). In 1990, Hiraoka, et al. published a paper describing the optical properties of the fluorescence microscope. In this paper, Hiraoka introduced the concept of the Partial Confocal Effect. The Partial Confocal Effect is based upon the observation that the axial resolution of a fluorescence microscope exceeds theoretical predictions. Hiraoka's paper does not, however, explain the source of this unexpected resolution effect.

Starting in 1992, Applied Precision, assignee of the present application, began work to develop fully and to commercialize the image restoration microscope described by Sedat, et al; in that regard, research included systematic studies regarding the Partial Confocal Effect. As set forth in more detail below, a system and methodology optimizing the Partial Confocal Effect for wide-field microscopy are described.

### SUMMARY

Embodiments of the present invention overcome the above-mentioned and various other shortcomings of conventional technology, providing a system and method optimizing fluorescence illumination for three-dimensional microscopy applications. Some embodiments allow selective and repeatable switching between Köhler illumination, providing a relatively large field of view, and Critical Illumination, providing relatively higher axial resolution.

In accordance with some exemplary embodiments, an illumination assembly generally comprises: a focusing lens assembly operative to receive excitation light from an excitation light source; a light transmission conduit coupled to the focusing lens assembly and operative to transmit the excitation light; and an alignment module coupled to the transmission conduit and operative selectively to focus the excitation light in accordance with a selected illumination strategy.

The light transmission conduit may be embodied as or comprise an optical fiber, which may be constructed of fused silica, for example, or other material known in the art or developed and operative in accordance with known principles of light transmission. The alignment module may generally be operative to provide the excitation light to a fluorescence microscopy system.

As set forth in more detail below, the illumination assembly may incorporate an alignment module operative selectively to adjust the location and orientation of the light transmission conduit relative to a collimating lens; additionally, the alignment module may be operative selectively to enable Köhler illumination and Critical illumination, among other illumination strategies.

In accordance with another aspect of the present invention, an illumination optimization method generally comprises coupling a focusing lens assembly to an excitation light source, transmitting excitation light to an excitation light alignment module, and focusing the excitation light according to a selected illumination strategy. Additionally, the illumination optimization method may further comprise transmitting the excitation light to a microscopy system, such as an epifluorescent microscopy system.

In some embodiments, an illumination optimization method may further comprise selecting the illumination strategy from one of a plurality of pre-programmed or stored strategies. Additionally, an illumination optimization method may comprise selectively repeating the selecting and the focusing; the selecting, the focusing, or both may generally comprise utilizing a microprocessor.

As set forth in more detail below, the focusing may comprise focusing the excitation light onto the back aperture of an objective lens; alternatively the focusing may comprise focusing the excitation light on the object plane.

The foregoing and other aspects of various embodiments of the present invention will be apparent through examination of the following detailed description thereof in conjunction with the accompanying drawings.

### BRIEF DESCRIPTION OF THE DRAWINGS

FIG. 1 is a simplified functional block diagram illustrating one embodiment of a fluorescence microscopy system.

FIG. 2 is a simplified functional block diagram illustrating a portion of the fluorescence microscopy system depicted in FIG. 1.

FIG. 3 is a simplified graph depicting the Partial Confocal Effect as a function of illumination focus and field of view.

FIG. 4 is a simplified block diagram illustrating maximum defocus and maximum density gradient illumination techniques.

FIG. 5 is a simplified illustration of one embodiment of an illumination assembly.

FIG. 6 is a simplified partial cross-sectional diagram illustrating one embodiment of a fiber optic alignment module.

FIG. 7 is a simplified flow diagram illustrating one embodiment of an illumination optimization method.

### DETAILED DESCRIPTION

By way of additional background, potential sources of the Partial Confocal Effect are described substantially as set forth below. Initially, it will be appreciated by those of skill in the art that the most common form of fluorescence microscope is generally referred to as an epifluorescence microscope. In this context, “epifluorescence” generally implies that the incidence illumination comes from the same direction (or side of the illuminated sample) from which fluorescence is detected.

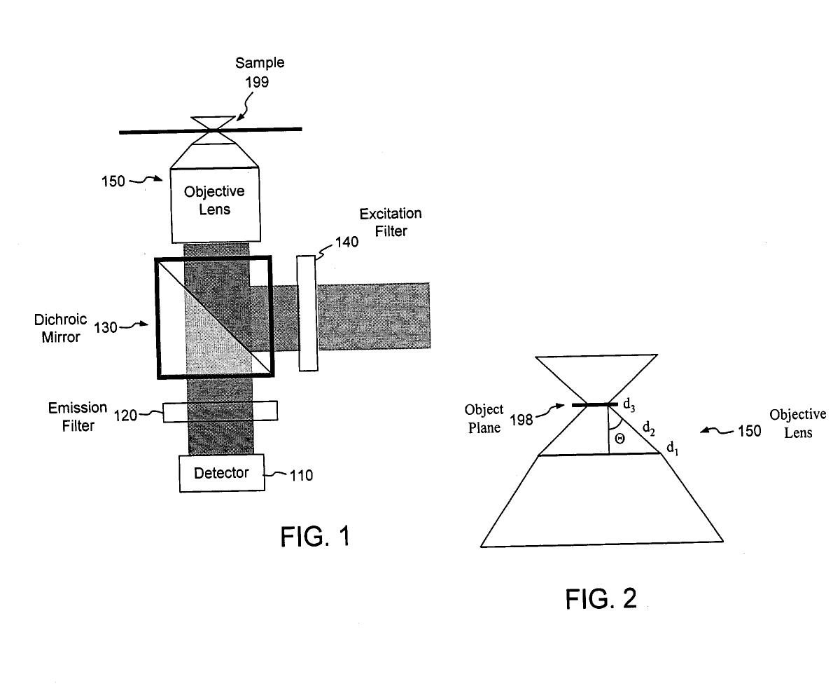

In that regard, FIG. 1 is a simplified functional block diagram illustrating one embodiment of a fluorescence microscopy system, and FIG. 2 is a simplified functional block diagram illustrating a portion of the fluorescence microscopy system depicted in FIG. 1.

In practice, the foregoing epifluorescence methodology may be accomplished by focusing a bright light source, such as a mercury arc lamp, for example (not illustrated in FIG. 1), through an excitation filter 140 configured and operative to select a narrow spectrum of light (the excitation band). This excitation band of light is reflected off a semi-reflective mirror such as dichroic mirror 130, for example. It will be appreciated that dichroic mirror 130 may be reflective in some portions of the color spectrum, but transmissive in others. The reflective and transmissive bands reflected off dichroic mirror 130 may be selected to coincide with the excitation and emission spectra of the fluorescent molecule being studied (e.g., sample 199). The fluorescent molecules absorb the excitation band of light and emit a different spectrum of light (the emission band).

In some implementations, an emission filter 120 may be positioned between the emissive material and the detector 110 (such as, for example, the human eye, a camera, etc.) to restrict the detection to the emission band. As noted generally above, the FIG. 1 arrangement is typically referred to as epifluorescent, since the excitation and emission band both come from the same side of the specimen or sample 199. In fact, both the excitation band incident on sample 199 and the emission band incident on detector 110 pass through the same objective lens 150 or other optical assembly comprising or incorporating objective lens 150.

Since the excitation band traverses through objective 150, the excitation band may be focused onto the object plane 198 where the specimen or sample 199 is located. The angle of convergence of the rays from the front lens of the objective to the sample is given by:

$$Θ = arcsin [ \frac{NA}{n} ] \qquad ( Equation 1 )$$

where NA is the numerical aperture of objective lens 150, n is the refractive index of the immersion medium, and θ is the half-angle of light focused by objective lens 150. This geometry is indicated in FIG. 2.

It may be assumed that most of the photons within the excitation band arrive at the sample 199; accordingly, the density of photons (photons/area) must increase as the light is focused. In FIG. 2, as a fixed number of photons move from d1 to d2 to d3, the density of those photons must also increase. For a constant mass of fluorescent material at sample 199, the intensity (photon density) of the emission band will generally increase in proportion to the intensity (photon density) of the excitation band. That is, as the photon density of the excitation band increases, the intensity of the emission band increases; conversely, as the photon density decreases, the intensity of the emission band decreases. As a consequence, as the excitation band is more tightly focused onto object plane 198, an increasing proportion of the emitted fluorescence will originate from object plane 198, and proportionally less will originate from planes above and below object plane 198.

The foregoing proportional relationship, in turn, tends to generate a substantial increase in axial resolution, i.e., resolution into and out of the focal plane of objective lens 150 or the optical system in general. This increased axial resolution is generally referred to in the art as the Partial Confocal Effect.

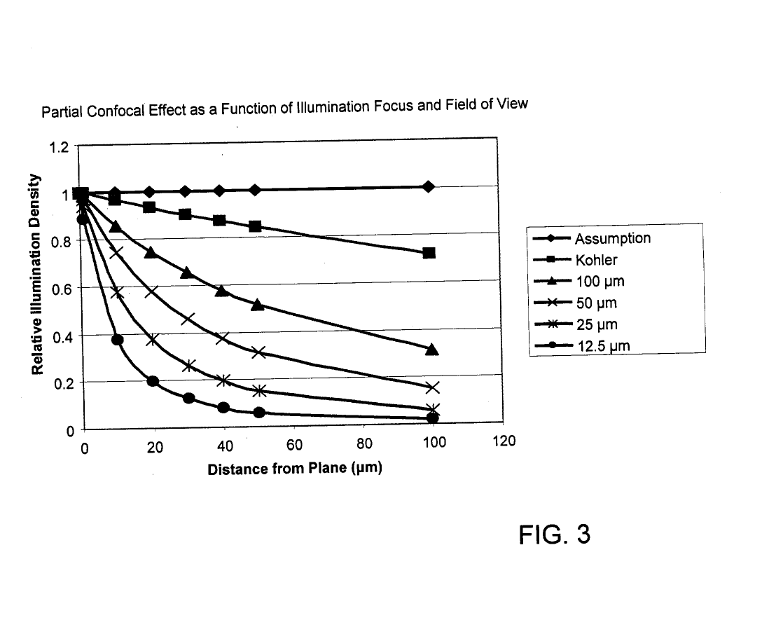

FIG. 3 is a simplified graph depicting the Partial Confocal Effect as a function of illumination focus and field of view. One potential inference to be drawn from the FIG. 3 plot is that illumination density is constant throughout the focal range, as indicated by the horizontal line along density equals 1. Expert users often align the fluorescence microscopes to achieve Köhler illumination (see Inoue and Spring, 1997). Using this illumination technique, the illumination is maximally defocused in the object plane by focusing the illumination onto the back aperture of the objective lens. In Köhler illumination, for instance, the field stop aperture is also closed such that it just fills the field of view. As can be seen through examination of FIG. 3, this form of illumination generally produces less than optimal axial resolution.

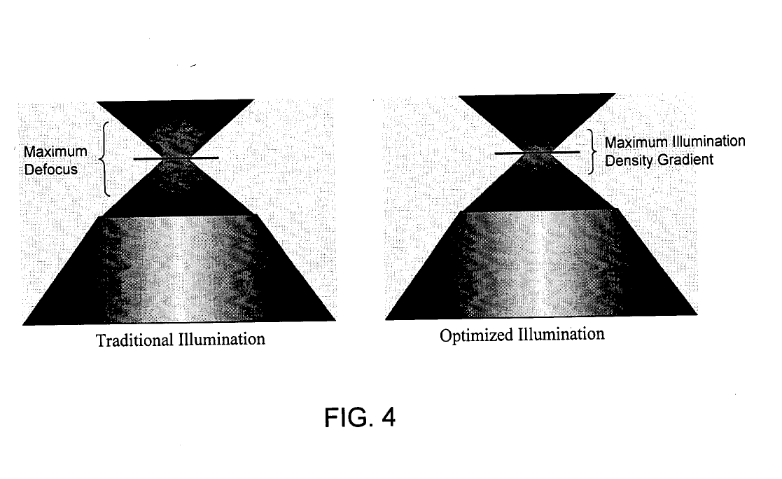

The potential benefits of the Partial Confocal Effect are often minimized by traditional illumination system design and techniques. For example, the illumination source for fluorescence microscopy is nearly always a short arc lamp with mercury, xenon, mercury-halide, or other elements used for excitation light generation. In these short wavelength arc lamps, a plasma field is established by voltage arcing from anode to cathode electrodes within the lamp. This energizes the elements within the bulb, causing the elements to emit photons. The plasma field is a complex, dynamic, 3D structure. Microscope manufacturers attempt to design the illumination optics to minimize artifacts arising from such illuminating techniques using plasma fields. For example, the illumination system may be designed to project the image of the arc lamp onto the back aperture of the objective lens. In this way, the image of the illumination source (the arc lamp) is maximally defocused onto the object plane. This is why the Köhler type of alignment is often selected. Even with Köhler illumination, however, a portion of the 3D image of the arc lamp is projected onto the object plane. This further decreases the illumination density gradient at the object plane and, therefore, minimizes the Partial Confocal Effect, as indicated generally in FIG. 4.

In that regard, FIG. 4 is a simplified block diagram illustrating maximum defocus and maximum density gradient illumination techniques. In order to achieve the optimized illumination pattern illustrated at the right side of FIG. 4, it becomes necessary to eliminate the image of the arc lamp projected onto the back aperture of the objective lens.

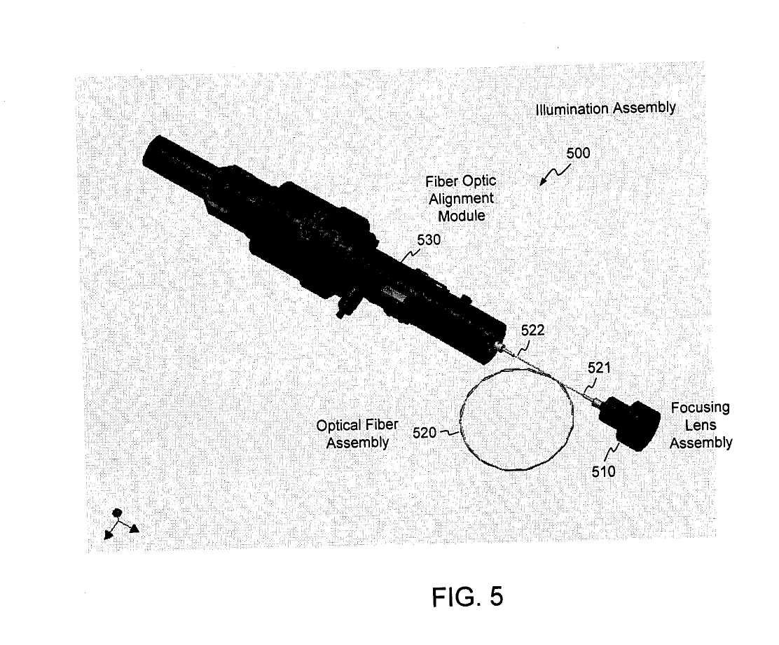

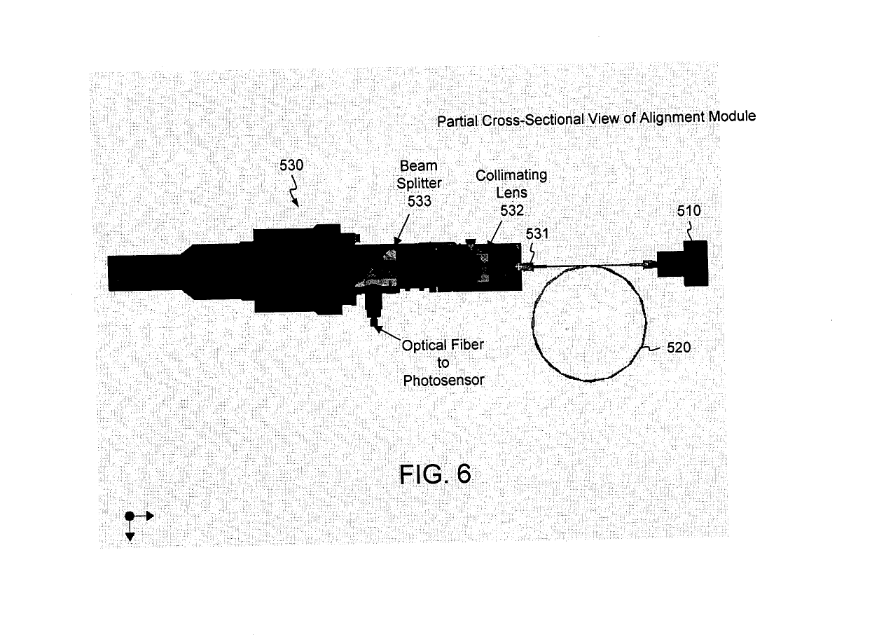

FIG. 5 is a simplified illustration of one embodiment of an illumination assembly, and FIG. 6 is a simplified partial cross-sectional diagram illustrating one embodiment of a fiber optic alignment module.

It will be appreciated that aspects of the present invention generally pertain to providing a system and method enabling an operator of a fluorescence microscope to establish and to maintain an optimal illumination pattern on the object plane in order to maximize the Partial Confocal Effect and, therefore, to optimize axial resolution. In this context, one embodiment of such a system may incorporate an illumination assembly 500. As illustrated in FIGS. 5 and 6, assembly 500 may generally comprise three components: a focusing lens assembly 510; a light transmission conduit such as, for instance, an optical fiber 520; and a fiber optic alignment module 530.

In accordance with some exemplary embodiments, the image of the arc lamp (not illustrated in FIGS. 5 and 6) may be projected onto the tip of optical fiber 520. This projection, in essence, may “launch,” or transmit, a portion of the excitation light generated by the arc lamp into optical fiber 520. The diameter and numerical aperture of fiber 520 may be selected in accordance with system parameters, for example, in order to capture as much light as possible. Additionally, the components of lens assembly 510 may be optimally configured such that excitation light may enter fiber 520 at a selected or predetermined angle, for example, which may be related to the numerical aperture of fiber 520 or other factors, in order to control the light rays propagating through fiber 520.

The embodiment of FIGS. 5 and 6, for instance, exemplifies one design that meets the foregoing and other goals. Since microscopists using fluorescence often employ techniques using a broad range of wavelengths for exciting the fluorescence molecules, the focusing lens assembly 510 may also be selected to optimize the collection of a wide range of wavelengths. In accordance with the present disclosure, a fused silica lens may be appropriate for incorporation at lens assembly 510. Other alternatives such as quartz, for example, may also be employed in accordance with system requirements and optical parameters.

As indicated above, one embodiment of a light transmission conduit may include or comprise optical fiber 520. The specific material selected for optical fiber 520 may be affected or influenced by, for example, the range of wavelengths with which the fluorescent molecules are to be imaged, the diameter, length, and general arrangement of fiber 520, other optical loss factors, and various other system parameters. In order to permit the broadest range of wavelengths possible, optical fiber 520 may comprise or be embodied as fused silica. Those of skill in the art will appreciate that other fiber materials may be employed in alternative embodiments. The dimensions (e.g., diameter and length) of fiber 520 may generally influence the performance of the illumination optics, as may kinks, bends and other curves, or other directional aspects of the optical fiber.

In accordance with some embodiments, ray paths entering fiber 520 at the source end 521 may be adequately or sufficiently mixed so as to eliminate any image of the arc lamp emanating from the distal end 522 of fiber 520. Additionally, an operative system with which assembly 500 is implemented may require a predetermined or sufficient illumination intensity so as to permit imaging of scant quantities of fluorescent molecules contained in the sample. Accordingly, the numerical aperture of fiber 520, as well as fiber diameter and length, may all be suitably selected to cooperate with the excitation band and intensity emitted by the source. In one embodiment, for example, a 0.38 NA fiber having a diameter of 1 mm may be up to four meters in length, depending, for example, upon the operational characteristics of the source of excitation illumination, the required illumination intensity incident on the sample, and other factors.

In addition, fiber 520 may be coiled or otherwise spatially manipulated so as to “mix” the light entering fiber 520 in accordance with wavelength requirements at the sample. As noted generally above, one exemplary embodiment satisfying the above-mentioned criteria is illustrated in simplified form in FIGS. 5 and 6.

In accordance with one aspect of the present system and method, subsequent to the image of the arc lamp being properly collected and mixed as set forth above, the image may then be aligned to the optical axis of the microscope. In that regard, FIG. 6 illustrates one embodiment of a suitable alignment module 530. Module 530 may generally permit up to eight axes of motion to assure proper alignment of incident excitation illumination along the optical axis. In some embodiments, module 530 may attach to the fluorescence illuminator provided by the microscope manufacturer, for example, at two translation axes, X and Y. Module 530 may then tilt in two axes (pitch and yaw). In the FIG. 6 embodiment, fiber 520 may be attached to the distal end 531 of module 530 where it may also be translated in two axes (X and/or Y). Finally, the location of the fiber tip relative to the collimating lens 532 may be variable, providing for focus of the fiber tip along the optical axis. Once fiber 520 is properly aligned and focused, the illuminating excitation light may be optimally projected onto the object plane.

In the foregoing and other embodiments, the image of the arc lamp may be replaced with the image of the fiber optic tip. Since this tip may be manufactured to tight and uniform tolerances, the image of the tip may be used to optimize the Partial Confocal Effect. Since the tips of optical fibers currently manufactured are typically uniform and unchanging, a further improvement becomes possible.

As generally set forth above, Köhler illumination focuses the illumination onto the back aperture of the objective lens. This maximally homogenizes the illumination and produces the largest field of view. A different form of alignment allows illumination which is focused directly onto the object plane. This technique is generally referred to as Critical Illumination. Critical Illumination, in this context, is not normally used in conjunction with conventional fluorescence microscopes because the inhomogeneous image of the arc would be projected onto the object plane. However, in the embodiments set forth herein, the image of the fiber tip may be projected onto the object plane. Since this projection is uniform, it does not diminish the image quality. Furthermore, using Critical Illumination further increases the concentration of the illumination onto the object plane, further enhancing the Partial Confocal Effect while increasing the illumination intensity at the object plane by a factor of approximately 2 to 4.

Critical Illumination techniques, on the other hand, may significantly decrease the field of view. As described above, such a decreased field of view may be considered a positive aspect in terms of the axial resolution, since axial resolution varies in inverse proportion to field of view. However, certain applications, such as locating features of interest, for example, may require or benefit from a relatively larger field of view. Accordingly, one aspect of the flexible embodiment described above is a focusing mechanism that allows the microscopist easily to switch between Köhler illumination (largest field of view) and Critical Illumination (highest axial resolution). This switching or toggle function may be facilitated by a feature on the module 530 that allows the focus of the fiber tip to be selectively and repeatably transitioned between the back aperture of the objective lens and the object plane without losing optical alignment.

In that regard, module 530 may incorporate, comprise, or be coupled to appropriate mechanisms to enable the multiple axis movement of the optical fiber tip set forth above. Numerous drive mechanisms, gimbals, linear actuators, and other mechanical devices and structures are generally known in the art. The present disclosure is not intended to be limited by the specific structure or methodology employed to align the fiber tip relative to collimating lens 532 depicted in FIG. 6.

It will be appreciated that the alignment module 530 of FIG. 6 may be operative selectively to adjust the relative location and orientation of the fiber tip with respect to collimating lens 532 substantially as set forth above. Accordingly, adjustments made at module 530 may enable a fluorescent microscopy system with which assembly 500 is employed selectively to switch between Köhler illumination and Critical Illumination strategies. Module 530 may additionally be configured and operative to provide or selectively to adjust the excitation light in accordance with various other predetermined or dynamically adjustable illumination strategies, depending, for example, upon the various mechanisms implemented to control the position and orientation of the fiber tip.

In some embodiments, for example, static and dynamic placement of the fiber tip may be automated, for instance, using microcontrollers and electromechanical actuators. In this case, one or more input devices (such as a keyboard or keypad, a mouse, etc.) for example, may enable selection of any of a plurality of programmed or pre-set illumination strategies; additionally, microcontroller or microprocessor control may enable active manipulation or alteration of pre-set parameters, as well as customization or dynamic configuration of illumination parameters.

In general, it will be appreciated that movement of the plasma field within the arc lamp may typically be translated into variations in the illumination pattern in the object plane; alternatively, the illumination pattern may remain fixed and uniform, while the intensity of the illumination may be more variable. To compensate for these effects, the module 530 may incorporate or comprise a beam splitter 533 configured and operative to divert a small fraction (approximately 1%, for example) of the illumination light to an optical fiber that terminates at a photosensor. In accordance with this aspect of the disclosed embodiments, the photosensor may monitor the intensity of the illumination light. Since a fixed proportion of the illumination light is diverted, this fixed proportion may be used as a surrogate measure of the incident light intensity. This measure of the incident light may then be used by software, for example, or hardware processing apparatus, to compensate for any intensity fluctuations at the object plane. In some embodiments employing automated or microprocessor controlled movement of the fiber tip, feedback provided by the fixed proportion of incident light may be used in conjunction with an active control loop, for example.

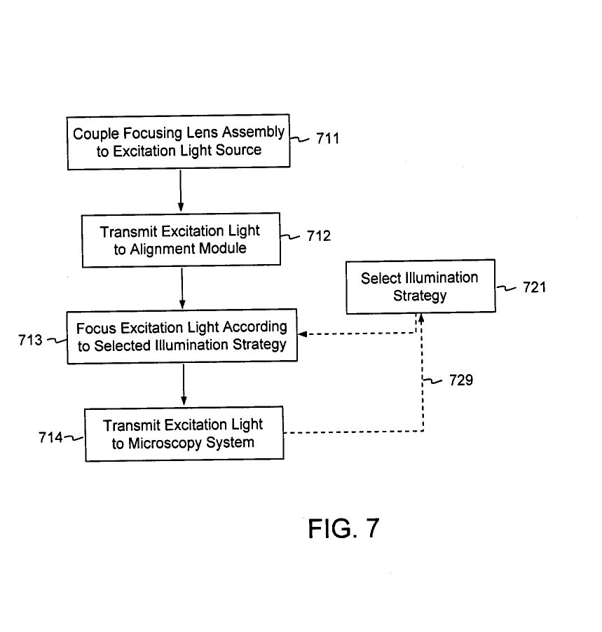

FIG. 7 is a simplified flow diagram illustrating one embodiment of an illumination optimization method. It will be appreciated that the method depicted in FIG. 7 may incorporate the modules and components described in detail above with reference to FIGS. 5 and 6.

As indicated at block 711, an illumination optimization method may begin by coupling a focusing lens assembly to an excitation light source. As set forth above, a focusing lens assembly in this context may generally comprise one or more lenses or optical components configured and operative to receive excitation light and to direct same into a light transmission conduit. Additionally, optical and other components of such a focusing lens assembly may be selected such that excitation light may enter the light transmission conduit at a predetermined or optimal angle, for example, which may be related to the numerical aperture associated with the transmission conduit or other factors.

The light transmission conduit may be embodied as an optical fiber, for example, though other embodiments of such a conduit are contemplated herein. In some exemplary embodiments, an optical fiber may comprise fused silica or other material suitable for propagation of light at a desired wavelength or wavelength band, as is generally known in the art. The length and dimensional characteristics of such a light transmission conduit may generally be selected in accordance with system requirements including, but not limited to: the NA and other attenuation factors contributed by the particular material selected for the transmission conduit; excitation light intensity requirements at the sample, which may be application specific; and so forth.

At blocks 712 and 713, excitation light may be transmitted through the focusing lens assembly, through the light transmission conduit, and into an alignment module where the excitation light may be focused substantially as set forth above with reference to FIGS. 5 and 6. In particular, such an alignment module may be configured and operative to manipulate light received from the transmission conduit in a desired or pre-selected way. In accordance with some embodiments, for instance, the fiber tip or other terminus of the light transmission conduit may be selectively manipulated or spatially oriented in three dimensions relative to a collimating lens or other optical components.

Appropriate actuators, servos, gimbals, and other mechanical elements to effectuate such manipulation are generally known in the art. As set forth above, the foregoing or other mechanical elements may be automatically controlled by one or more microcontrollers or microprocessors, for example. Additionally or alternatively, light waves received from the transmission conduit may be selectively controlled by optical elements (such as collimating mirrors, lenses, filters, gratings, or other suitable components) incorporated in or associated with the alignment module. Incidence, reflection, and refraction angles relative to the optical axis of the alignment module may be adjusted or controlled through precise modification of the spatial relationships of such components within or with respect to the alignment module; this modification and selective adjustment may be facilitated by a microprocessor, for example, as set forth above.

As indicated at block 713 and set forth above, adjustment or alteration of excitation light in or effected by the alignment module may be made in accordance with a selected illumination strategy. In the FIG. 7 embodiment, a particular illumination strategy may be selected, for instance, as indicated at block 721. By way of example, Köhler illumination may provide a relatively large field of view for fluorescence microscopy applications, while Critical Illumination may provide a relatively higher axial resolution in the same applications. The foregoing and various other illumination strategies may be pre-programmed into computer memory or other storage media, for example, and may be selected via one or more input devices as set forth above, directing one or more processor controlled actuator systems to manipulate structural components accordingly. Additionally or alternatively, one or more structural components or devices within or associated with the alignment module may be dynamically controlled by a microscopist employing a system incorporating an alignment module such as illustrated and described herein.

At block 714, excitation light appropriately manipulated by the alignment module may be directed or transmitted to a microscopy system with which the alignment module is associated or coupled. As indicted generally by the dashed arrow 729 looping back to block 721, selection of an alternative illumination strategy may occur automatically under microprocessor control, for example, after a predetermined or pre-selected time, or alternatively under active control of a microscopist or other researcher.

It will be appreciated that the specific arrangement represented by the blocks in FIG. 7 is not intended to imply an order of operations to the exclusion of other possibilities. In particular, the operation depicted at block 721 may occur at various locations in the flow depicted in FIG. 7, for example, preceding the operations depicted in blocks 711 and 712. In some instances, an illumination strategy may be selected or determined prior to selecting or transmitting excitation light from a particular light source; in that regard, it will be appreciated that the selected illumination strategy may influence or otherwise affect either the choice of a particular illumination source, the operations at or associated with the focusing lens assembly, or both. Additionally or alternatively, the selection represented at block 721 may be selectively or automatically repeated as desired or required.

Aspects of the present invention have been illustrated and described in detail with reference to particular embodiments by way of example only, and not by way of limitation. Those of skill in the art will appreciate that various modifications to the exemplary embodiments are within the scope and contemplation of the present disclosure. It is intended, therefore, that the present invention be limited only by the scope of the appended claims.

1. An illumination assembly comprising:
a focusing lens assembly operative to receive excitation light from an excitation light source;
a light transmission conduit coupled to said focusing lens assembly and operative to transmit said excitation light; and
an alignment module coupled to said transmission conduit and operative selectively to focus said excitation light in accordance with a selected illumination strategy.

2. The illumination assembly of claim 1 wherein said a light transmission conduit is an optical fiber.

3. The illumination assembly of claim 2 wherein said optical fiber comprises fused silica.

4. The illumination assembly of claim 1 wherein said alignment module is operative to provide said excitation light to a fluorescence microscopy system.

5. The illumination assembly of claim 1 wherein said alignment module is operative selectively to adjust the location and orientation of said light transmission conduit relative to a collimating lens.

6. The illumination assembly of claim 4 wherein said alignment module is operative selectively to enable Köhler illumination.

7. The illumination assembly of claim 4 wherein said alignment module is operative selectively to enable Critical illumination.

8. An illumination optimization method comprising:
coupling a focusing lens assembly to an excitation light source;
transmitting excitation light to an excitation light alignment module; and
focusing said excitation light according to a selected illumination strategy.

9. The illumination optimization method of claim 8 further comprising transmitting said excitation light to a microscopy system.

10. The illumination optimization method of claim 8 further comprising selecting said illumination strategy.

11. The illumination optimization method of claim 10 further comprising selectively repeating said selecting and said focusing.

12. The illumination optimization method of claim 10 wherein said focusing comprises utilizing a microprocessor.

13. The illumination optimization method of claim 12 wherein said selecting comprises utilizing said microprocessor.

14. The illumination optimization method of claim 8 wherein said focusing comprises focusing said excitation light onto a back aperture of an objective lens.

15. The illumination optimization method of claim 8 wherein said focusing comprises focusing said excitation light onto an object plane.
